(19) United States
(12) Patent Application Publication
(10) Pub. No.: US 2021/0033706 A1
(43) Pub. Date: Feb. 4, 2021

(54) METHODS AND SYSTEMS FOR AUTOMATICALLY LABELING POINT CLOUD DATA

(71) Applicant: TOYOTA RESEARCH INSTITUTE, INC., Los Altos, CA (US)

(72) Inventor: Hiroyuki Funaya, Ann Arbor, MI (US)

(73) Assignee: TOYOTA RESEARCH INSTITUTE, INC., Los Altos, CA (US)

(21) Appl. No.: 16/526,569

(22) Filed: Jul. 30, 2019

(51) Int. Cl. G01S 7/48; G06K 9/00; G05D 1/00; G01S 17/89; G05B 13/02; G06F 16/22

(52) U.S. Cl. CPC G01S 7/4808; G06K 9/00791; G05D 1/0088; G05D 2201/0213; G05B 13/0265; G06F 16/2228; G01S 17/89

(57) ABSTRACT

Methods and systems for automatically labeling point cloud data are disclosed. A method includes obtaining the point cloud data from vehicle sensor modules, randomly selecting three points from the point cloud data, generating a plane hypothesis pertaining to the three points via a random sample consensus (RANSAC) method, selecting one or more points from the point cloud data that are inliers based on the plane hypothesis, sorting the selected points based on a corresponding dataset received from the vehicle sensor modules such that each of a plurality of datasets includes one or more selected points therein, completing a range RANSAC method on each of the datasets to determine one or more inliers of the selected points, repeating each process until a loss function of the range RANSAC method does not decrease, and automatically labeling the inliers of the selected points in each of the plurality of datasets.

### FIELD

The present disclosure relates to methods and systems for automatically labeling components within point cloud data, and more specifically, for using a modified RANSAC model to determine whether particular points in the point cloud data correspond to ground or non-ground objects.

### BACKGROUND

Point cloud data obtained by LIDAR and/or other sensor modules is generally labeled to ensure usefulness of the data. For example, LIDAR data that is collected by autonomous and/or semi-autonomous vehicles may be labeled such that autonomous and/or semi-autonomous vehicle systems can discern objects around the vehicle and make decisions accordingly. Sometimes, the data has to be hand labeled by humans. As such, the data cannot always be immediately used for the purposes of real-time autonomous system and/or semi-autonomous system decision making.

### SUMMARY

One aspect of the present disclosure relates to a method of automatically labeling point cloud data. The method includes obtaining, by a processing device, the point cloud data from one or more vehicle sensor modules. The method further includes randomly selecting, by the processing device, three points from the point cloud data. The method further includes generating, by the processing device, a plane hypothesis pertaining to the three points via a random sample consensus (RANSAC) method. The method further includes selecting, by the processing device, one or more points from the point cloud data that are inliers based on the plane hypothesis. The method further includes sorting, by the processing device, the selected one or more points based on a corresponding dataset received from the one or more vehicle sensor modules such that each of a plurality of datasets includes one or more selected points therein. The method further includes completing, by the processing device, a range RANSAC method on each of the plurality of datasets to determine one or more inliers of the one or more selected points. The method further includes repeating, by the processing device, the randomly selecting, the generating, the selecting, the sorting, and the completing until a loss function of the range RANSAC method does not decrease. The method further includes automatically labeling, by the processing device, the one or more inliers of the one or more selected points in each of the plurality of datasets.

Another aspect of the present disclosure relates to a system for automatically labeling point cloud data. The system includes one or more hardware processors and a non-transitory, processor-readable storage medium having one or more programming instructions thereon. The one or more programming instructions, when executed, cause the one or more hardware processors to obtain the point cloud data from one or more vehicle sensor modules, randomly select three points from the point cloud data, generate a plane hypothesis pertaining to the three points via a random sample consensus (RANSAC) method, select one or more points from the point cloud data that are inliers based on the plane hypothesis, sort the selected one or more points based on a corresponding dataset received from the one or more vehicle sensor modules such that each of a plurality of datasets includes one or more selected points therein, complete a range RANSAC method on each of the plurality of datasets to determine one or more inliers of the one or more selected points, repeat the randomly selecting, the generating, the selecting, the sorting, and the completing until a loss function of the range RANSAC method does not decrease, and automatically label the one or more inliers of the one or more selected points in each of the plurality of datasets.

Yet another aspect of the present disclosure relates to a vehicle that includes one or more vehicle sensor modules arranged to sense an environment surrounding the vehicle and a labeling system communicatively coupled to the one or more vehicle sensor modules. The labeling system includes one or more hardware processors and a non-transitory, processor-readable storage medium having one or more programming instructions thereon. The one or more programming instructions, when executed, cause the one or more hardware processors to obtain the point cloud data from one or more vehicle sensor modules, randomly select three points from the point cloud data, generate a plane hypothesis pertaining to the three points via a random sample consensus (RANSAC) method, select one or more points from the point cloud data that are inliers based on the plane hypothesis, sort the selected one or more points based on a corresponding dataset received from the one or more vehicle sensor modules such that each of a plurality of datasets includes one or more selected points therein, complete a range RANSAC method on each of the plurality of datasets to determine one or more inliers of the one or more selected points, repeat the randomly selecting, the generating, the selecting, the sorting, and the completing until a loss function of the range RANSAC method does not decrease, and automatically label the one or more inliers of the one or more selected points in each of the plurality of datasets.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 schematically depicts a perspective view of an illustrative vehicle including one or more vehicle sensor modules, the vehicle adjacent to a non-ground object according to one or more embodiments shown and described herein;

FIG. 2A depicts a block diagram of illustrative internal components of a labeling system and illustrative internal components of a sensor module in a vehicle having one or more data collection devices according to one or more embodiments shown and described herein;

FIG. 2B depicts a block diagram of illustrative logic modules located within a memory of a labeling system of a vehicle according to one or more embodiments shown and described herein;

FIG. 2C depicts a block diagram of illustrative types of data contained within a storage device 256 of a labeling system of a vehicle according to one or more embodiments shown and described herein;

FIG. 3 schematically depicts an arrangement of points from point cloud data indicating at least one point not located on a ground surface according to one or more embodiments shown and described herein;

FIG. 4 depicts a plot of points and associated ranges according to one or more embodiments shown and described herein;

FIG. 5 schematically depicts an arrangement of points from point cloud data of three beam sweeps indicating one or more outliers in a range domain and used for generating a plane hypothesis and a line hypothesis according to one or more embodiments shown and described herein;

FIG. 6 depicts a flow diagram of an illustrative method of determining a loss function according to one or more embodiments shown and described herein; and

FIG. 7 depicts a flow diagram of an illustrative method of generating a joint model using range regression and plane regression to determine whether one or more points in point cloud data and/or image data corresponds to a ground object or a non-ground object according to one or more embodiments shown and described herein.

### DETAILED DESCRIPTION

The present disclosure generally relates to vehicles, systems, and methods for automatically labeling point cloud data. The labeled data can be used by artificial intelligence (AI) systems, such as, for example, machine learning (ML) components, for the purposes of identifying objects from point cloud data. For example, AI components in autonomous and semi-autonomous vehicles need to identify objects in an environment around the vehicle to make decisions.

Small objects that are close to the ground surface around the vehicle and/or small indentations within the ground surface (e.g., pot holes or the like) may be difficult to discern using existing automated method of labeling point cloud data. This is because small objects that are only a few centimeters off the ground, such as road bumps, loose gravel, roadkill, and/or the like, may not be recognized from the point cloud data or may be tagged as being within a range of data that is generally accepted as being part of the road. As such, the data may only be recognized as part of the road surface and not objects independent of the road. In order for AI systems to realize that the data is indicative of objects that are not part of the road surface, the data must be manually labeled by a human user and input into the AI systems. These human labeling methods are inefficient, time consuming, and expensive.

The vehicles, systems, and methods described herein overcome this issue by recognizing that this point cloud data is actually not part of the road surface, but rather a non-road object. As such, by utilizing the vehicles, systems, and methods described herein, small, non-ground objects can be recognized from point cloud data and labeled accordingly. Data pertaining to the labeled non-ground objects can then be outputted to an external device, such as a ML server or the like, which can use the data to learn whether future point cloud data indicates small non-ground objects, thereby improving AI sensing in autonomous and semi-autonomous vehicles.

As used herein, the term “random sample consensus” (or RANSAC) refers to an iterative method to estimate parameters of a mathematical model from a set of observed data that contains outliers, when outliers are to be accorded no influence on the values of the estimates. The RANSAC method is generally a non-deterministic algorithm that produces a reasonable result only with a certain probability, with this probability increasing as more iterations are completed.

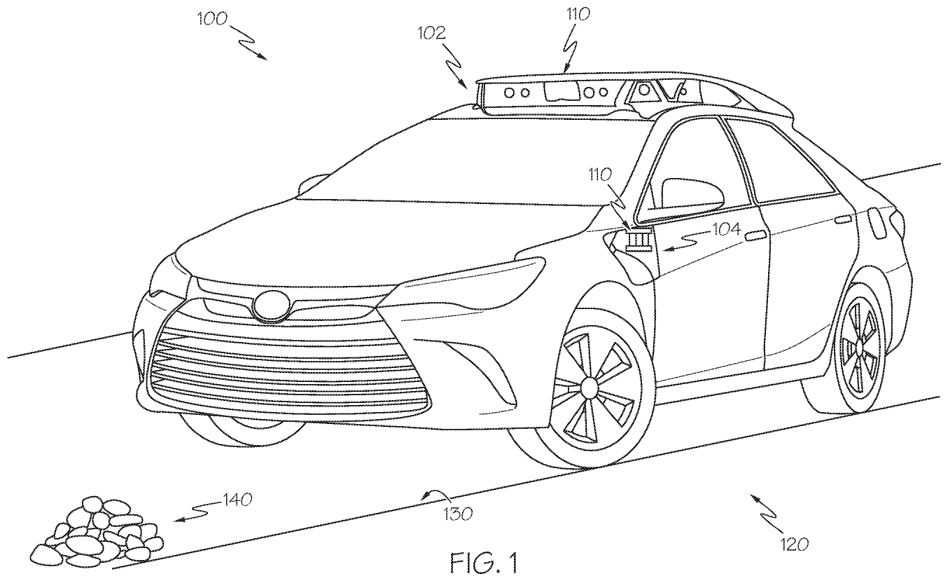

Referring now to the figures, FIG. 1 depicts an illustrative vehicle, generally designated 100. The vehicle 100 may generally be an autonomous vehicle or a semi-autonomous vehicle. That is, the vehicle 100 may contain one or more autonomous systems that allow the vehicle 100 to move autonomously (e.g., without a human driver controlling the vehicle 100) or semi-autonomously (e.g., with a human driver at least partially controlling the vehicle 100). It should be appreciated that a semi-autonomous vehicle may have one or more autonomous driving systems that can be engaged by a driver of the vehicle 100 so as to assist the driver. Illustrative examples of autonomous driving systems that may be located in a semi-autonomous vehicle include, but are not limited to, lane-keeping assist systems, traffic flow based cruise control systems, automatic parallel parking systems, automatic braking systems, and the like.

The vehicle 100 may generally include one or more vehicle sensor modules 110 arranged to sense an environment 120 surrounding the vehicle 100, particularly a ground surface 130 and/or one or more non-ground objects 140. In general, each of the one or more vehicle sensor modules 110 may be located on an exterior surface of the vehicle 100, such as, for example, a top 102 of the vehicle 100 and/or a side 104 of the vehicle 100. However, such a location is merely illustrative. That is, in other embodiments, certain ones of the one or more vehicle sensor modules 110 may be located elsewhere with respect to the vehicle 100, such as in an interior of the vehicle 100. It should be appreciated that certain ones of the one or more vehicle sensor modules 110 may be located in a position that allows the vehicle sensor modules 110 to obtain data in an area completely surrounding the vehicle 100 (e.g., a 360 degree view of an environment surrounding the vehicle 100). In some embodiments, the one or more vehicle sensor modules 110 (and/or a component thereof) may be integrated into existing components of the vehicle 100. In other embodiments, the one or more vehicle sensor modules 110 and/or components thereof may be standalone units integrated with the vehicle 100, not integrated into existing components.

The one or more vehicle sensor modules 110 are generally not limited by the present disclosure, and may be any sensors and/or related components that provide data that is used for the purposes of autonomous or semi-autonomous movement. Illustrative examples of sensor modules include, but are not limited to, image sensor modules (e.g., cameras), radar modules, LIDAR modules, and the like. In particular embodiments, the one or more vehicle sensor modules 110 may be one or more LIDAR devices, as described in greater detail herein.

While FIG. 1 depicts the one or more vehicle sensor modules 110 as a first sensor module located on the top 102 of the vehicle 100 and a second sensor module located on the side 104 of the vehicle 100, it should be understood that the present disclosure is not limited to two vehicle sensor modules 110, and that greater or vehicle sensor modules 110 may be used without departing from the scope of the present disclosure. For example, in some embodiments, the vehicle 100 may include a plurality of front-facing vehicle sensor modules 110, a plurality of side facing vehicle sensor modules 110 on either side of the vehicle 100, and/or a plurality of rear vehicle sensor modules 110. In such embodiments, the various vehicle sensor modules 110 may work in tandem with each other to obtain data regarding the environment 120 surrounding the vehicle 100 (including the ground surface 130 and/or the non-ground objects 140), as described in greater detail herein. In other embodiments, the various vehicle sensor modules 110 may work independently of one another to obtain data regarding the environment 120 surrounding the vehicle 100 (including the ground surface 130 and/or the non-ground objects 140).

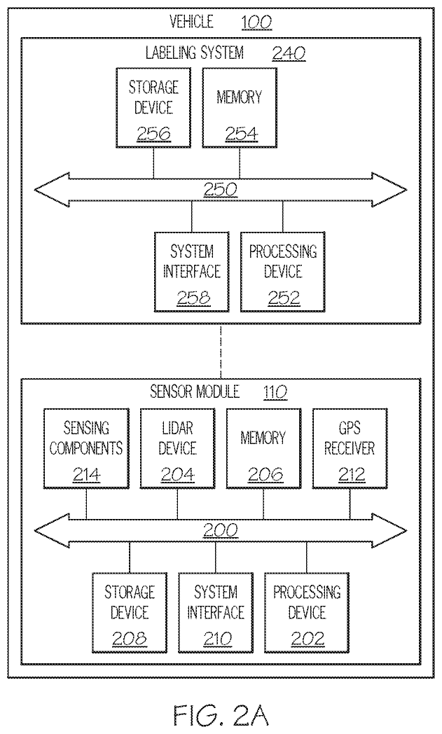

Referring now to FIG. 2A, each of the one or more vehicle sensor modules 110 includes various hardware components that provide the one or more vehicle sensor modules 110 with various sensing, data generation, and transmitting capabilities described herein. While only a single one of the one or more vehicle sensor modules 110 is depicted in FIG. 2A, it should be understood that all of the one or more vehicle sensor modules 110 may include the components depicted in FIG. 2A. A bus 200 may interconnect the various components, which include (but are not limited to) a processing device 202, a LIDAR device 204, memory 206, a storage device 208, system interface hardware 210, a GPS receiver 212, and/or one or more other sensing components 214. The processing device 202, such as a computer processing unit (CPU), may be the central processing unit of the vehicle sensor module 110, performing calculations and logic operations required to execute a program. The processing device 202, alone or in conjunction with one or more of the other elements disclosed in FIG. 2A, is an illustrative processing device, computing device, processor, or combination thereof, as such terms are used within this disclosure. The memory 206, such as read only memory (ROM) and random access memory (RAM), may constitute an illustrative memory device (i.e., a non-transitory processor-readable storage medium). Such memory 206 may include one or more programming instructions thereon that, when executed by the processing device 202, cause the processing device 202 to complete various processes, such as the processes described herein. In some embodiments, the program instructions may be stored on a tangible computer-readable medium such as a compact disc, a digital disk, flash memory, a memory card, a USB drive, an optical disc storage medium, such as a Blu-ray™ disc, and/or other non-transitory processor-readable storage media.

In some embodiments, the program instructions contained on the memory 206 may be embodied as a plurality of software logic modules, where each logic module provides programming instructions for completing one or more tasks. For example, certain software logic modules may be used for the purposes of collecting information or data (e.g., information or data from the environment 120 (FIG. 1) surrounding the vehicle 100 via the sensing components 214, the LIDAR device 204, the GPS receiver 212, and/or the like), extracting information or data, providing information or data, and/or the like.

Still referring to FIG. 2A, the storage device 208, which may generally be a storage medium that is separate from the memory 206, may contain one or more data repositories for storing data pertaining to collected information, particularly information sensed by the LIDAR device 204, the sensing components 214, the GPS receiver 212, and/or the like. The storage device 208 may be any physical storage medium, including, but not limited to, a hard disk drive (HDD), memory, removable storage, and/or the like. While the storage device 208 is depicted as a local device, it should be understood that the storage device 208 may be a remote storage device, such as, for example, a server computing device, one or more data repositories, or the like.

The system interface hardware 210 may generally provide the vehicle sensor module 110 with an ability to interface with one or more components of the vehicle 100, such as a labeling system 240, as described herein. The vehicle sensor module 110 may further communicate with other components of the vehicle 100 and/or components external to the vehicle 100 (e.g., remote computing devices, machine learning servers, and/or the like) without departing from the scope of the present application. Communication may occur using various communication ports (not shown). An illustrative communication port may be attached to a communications network, such as the Internet, an intranet, a local network, a direct connection, a vehicle bus (e.g., a CAN bus), and/or the like.

The LIDAR device 204 is generally a device that obtains information regarding the environment 120 (FIG. 1) surrounding the vehicle 100 using pulsed light. LIDAR, which stands for light detection and ranging (or light imaging, detection, and ranging), uses light in the form of a pulsed laser to measure ranges (distances) to objects. More specifically, the pulsed laser light is emitted by a LIDAR device and the reflected pulses, after being reflected off an object, are sensed by a sensor. Differences in reflected light return times and particular wavelengths thereof can be used to construct a digital three dimensional (3D) representation of the object(s) that reflect the light (e.g., a point cloud). It should be understood that a point cloud is generally a data array of coordinates in a particular coordinate system (e.g., in x, y, z space). That is, in 3D space, a point cloud includes 3D coordinates. The point cloud can contain 3D coordinates of visible surface points of a scene (e.g., an environment surrounding the vehicle 100 that is visible by the one or more vehicle sensor modules 110). It should further be understood that point cloud data is usable by computer programs (e.g., machine learning algorithms or the like) to construct a 3D model, determine an identity of objects, and/or the like, as described in greater detail herein.

It should be understood that the LIDAR device 204 is merely one example of a device that may be used to sense the environment 120 (FIG. 1) surrounding the vehicle 100. That is, the one or more other sensing components 214 may also be used to sense the environment surrounding the vehicle 100. The one or more other sensing components 214 may be components within the vehicle sensor module 110 that are in addition to the LIDAR device 204 and/or as an alternative to the LIDAR device 204. Illustrative examples of the one or more other sensing components 214 include, but are not limited to, imaging devices such as motion or still cameras, time of flight imaging devices, thermal imaging devices, radar sensing devices, and/or the like. The one or more other sensing components 214 may provide data that is supplemental to or in lieu of the data provided by the LIDAR device 204 for the purposes of labeling objects, as described in greater detail herein.

The GPS receiver 212 generally receives signals from one or more external sources (e.g., one or more global positing satellites), determines a distance to each of the one or more external sources based on the signals that are received, and determines a location of the GPS receiver 212 by applying a mathematical principle to the determined distances (e.g., trilateration). The GPS receiver 212 may further provide data pertaining to a location of the GPS receiver 212 (and thus the vehicle 100 as well) which may be used for labeling objects as discussed herein.

The vehicle 100 may further include a labeling system 240 therein. In some embodiments, the labeling system 240 may be communicatively coupled to the vehicle sensor module 110 such that signal, data, and/or information can be transmitted between the vehicle sensor module 110 and the labeling system 240. For example, signals, data, and/or information pertaining to one or more point clouds (e.g., point cloud data generated by the LIDAR device 204) may be transmitted from the vehicle sensor module 110 to the labeling system 240 such that the labeling system can identify points within the one or more point clouds that correspond to a ground or non-ground object and label the points accordingly, as described in greater detail herein.

A bus 250 may interconnect the various components, which include (but are not limited to) a processing device 252, memory 254, a storage device 256, and/or system interface hardware 258. The processing device 252, such as a computer processing unit (CPU), may be the central processing unit of the labeling system 240, performing calculations and logic operations required to execute a program. The processing device 252, alone or in conjunction with one or more of the other elements disclosed in FIG. 2A, is an illustrative processing device, computing device, processor, or combination thereof, as such terms are used within this disclosure. The memory 254, such as read only memory (ROM) and random access memory (RAM), may constitute an illustrative memory device (i.e., a non-transitory processor-readable storage medium). Such memory 254 may include one or more programming instructions thereon that, when executed by the processing device 252, cause the processing device 252 to complete various processes, such as the processes described herein. In some embodiments, the program instructions may be stored on a tangible computer-readable medium such as a compact disc, a digital disk, flash memory, a memory card, a USB drive, an optical disc storage medium, such as a Blu-ray™ disc, and/or other non-transitory processor-readable storage media.

In some embodiments, the program instructions contained on the memory 254 may be embodied as a plurality of software logic modules, where each logic module provides programming instructions for completing one or more tasks. For example, certain software logic modules may be used for the purposes of collecting information (e.g., point cloud data received from the vehicle sensor module 110), selecting points from data (e.g., point cloud data), generating hypotheses (e.g., a plane hypothesis, a range hypothesis, and/or the like), sorting data (e.g., selected points from a point cloud), completing various calculations (e.g., a range RANSAC method, computing loss functions, and/or the like), labeling data (e.g., labeling inliers or outliers from datasets), directing components (e.g., directing the vehicle sensor module 110 to activate, sense, and/or generate a point cloud), providing data (e.g., providing data to a machine learning device) and/or the like. Additional details regarding the logic modules will be discussed herein with respect to FIG. 2B.

Still referring to FIG. 2A, the storage device 256, which may generally be a storage medium that is separate from the memory 254, may contain one or more data repositories for storing data pertaining to point clouds, other sensed information, GPS data, hypothesis data (e.g., data generated as a result of generation of a plane hypothesis or a range hypothesis), sorting data, loss function data, labeling data (e.g., data generated as a result of labeling points in a point cloud or the like), and/or the like. The storage device 256 may be any physical storage medium, including, but not limited to, a hard disk drive (HDD), memory, removable storage, and/or the like. While the storage device 256 is depicted as a local device, it should be understood that the storage device 256 may be a remote storage device, such as, for example, a server computing device, a data repository, or the like. Additional details regarding the types of data stored within the storage device 256 are described with respect to FIG. 2C.

Still referring to FIG. 2A, the system interface hardware 258 may generally provide the labeling system 240 with an ability to interface with one or more components of the vehicle 100, such as each of the one or more vehicle sensor modules 110. The labeling system 240 may further communicate with other components of the vehicle 100 and/or components external to the vehicle 100 (e.g., remote computing devices, machine learning servers, and/or the like) without departing from the scope of the present application. For example, the labeling system 240 may transmit data pertaining to labeled points in a point cloud to an external device such as a machine learning device that utilizes the data to make one or more autonomous driving decisions (e.g., decisions pertaining to autonomously piloting the vehicle 100) or one or more semi-autonomous driving decisions (e.g., decisions pertaining to providing a driver with assistance in the form of braking, steering, and/or the like when the driver is driving the vehicle 100). Communication may occur using various communication ports (not shown). An illustrative communication port may be attached to a communications network, such as the Internet, an intranet, a local network, a direct connection, a vehicle bus (e.g., a CAN bus), and/or the like.

It should be understood that the components illustrated in FIG. 2A are merely illustrative and are not intended to limit the scope of this disclosure. More specifically, while the components in FIG. 2A are illustrated as residing within the vehicle sensor module 110 and/or within the labeling system 240, this is a nonlimiting example. In some embodiments, one or more of the components may reside external to the vehicle sensor module 110 and/or the labeling system 240, either within one or more other components of the vehicle 100, components external to the vehicle 100 (e.g., remote servers, machine learning computers, and/or the like), or as standalone components. As such, one or more of the components may be embodied in other computing devices not specifically described herein. In addition, while the components in FIG. 2A relate particularly to the vehicle sensor module 110 and the labeling system 240, this is also a nonlimiting example. That is, similar components may be located within other components without departing from the scope of the present disclosure.

Referring now to FIG. 2B, illustrative logic modules that may be contained within the memory 254 of the labeling system 240 (FIG. 2A) are depicted. Still referring to FIG. 2B, the logic modules may include, but are not limited to, data providing logic 260, data receiving logic 261, point selection logic 262, sorting logic 263, plane hypothesis logic 264, range hypothesis logic 265, inlier selection logic 266, outlier selection logic 267, range calculation logic 268, labeling logic 269, component directing logic 270, and/or loss function calculation logic 271.

The data providing logic 260 generally contains programming instructions for providing data to one or more external components. That is, the data providing logic 260 may include programming for causing the processing device 252 (FIG. 2A) to direct the system interface hardware 258 (FIG. 2A) to output data to one or more external components such as, for example, a machine learning device, the vehicle sensor module 110, one or more external computing devices, one or more other components of the vehicle 100, and/or the like. As such, the data providing logic 260 may include programming instructions that allow for a connection between devices to be established, protocol for accessing data stores, instructions for causing the data to be copied, moved, or read, and/or the like. In a particular embodiment, the data providing logic 260 includes programming for causing the processing device 252 (FIG. 2A) to direct the system interface hardware 258 (FIG. 2A) to output labeling data (e.g., data pertaining to automatically labeled point cloud points) to a machine learning device that uses the labeling data to make one or more autonomous driving decisions or one or more semi-autonomous driving decisions.

The data receiving logic 261 generally contains programming instructions for obtaining data that is used to carry out the various processes described herein. That is, the data receiving logic 261 may include programming for causing the processing device 252 (FIG. 2A) to direct the system interface hardware 258 to connect to the one or more vehicle sensor modules 110 to obtain data therefrom, such as, for example, LIDAR data (e.g., point cloud data), GPS data, and/or other data. As such, the data receiving logic 261 may include programming instructions that allow for a connection between devices to be established, protocol for requesting data stores containing data, instructions for causing the data to be copied, moved, or read, and/or the like. Accordingly, as a result of operating according to the data receiving logic 261, data and information pertaining to point clouds is available for completing various other processes, as described in greater detail herein.

The point selection logic 262 generally contains programming instructions for selecting one or more points in a point cloud. In some embodiments, the programming instructions may be particularly configured for randomly selected points from point cloud data. For example, randomly selected points may be selected for the purposes of generating a plane hypothesis, as described in greater detail herein. In other embodiments, the programming instructions may be particularly configured for selecting particular points in point cloud data. For example, the programming instructions may cause a selection of one or more points that are inliers based on a plane hypothesis.

The sorting logic 263 generally contains programming instructions for sorting particular points of a point cloud based on a dataset that contains selected points. For example, a particular dataset may be points that are generated as a result of a single beam sweep of a LIDAR device. That is, all of the points that are returned in a single beam sweep of a LIDAR device may be grouped together in the same dataset. The sorting logic 263 may include programming instructions for sorting points that have been selected that are within the dataset generated as a result of the single beam sweep of the LIDAR device.

The plane hypothesis logic 264 generally contains programming instructions for generating a plane hypothesis. That is, the programming instructions cause a plane to be generated based on one or more points in the point cloud, such as, for example, a plurality of randomly selected points. The plane hypothesis logic 264 may further include programming instructions for repeating the generation of a plane hypothesis repeatedly for different points, as described in greater detail herein. In some embodiments, the plane hypothesis logic 264 may generate a plane hypothesis using a random sample consensus (RANSAC) method. For example, assuming X₁, X₂, and X₃ are three randomly selected points from a point cloud, an origin p₀ and a normal vector n of the plane hypothesis π including those three points can be generated as follows:

p₀=X₁ n=c₁×c₂ (1)

where c₁=X₂−X₁ c₂=X₃−X₁

As soon as a plane hypothesis is generated with the three points, consensus for the hypothesis among other points is determined using a perpendicular distance from the plane. The perpendicular distance d_{⊥} for a 3D point Xᵢ from the plane π|p₀, n| can be calculated as follows:

d_{⊥}=(Xᵢ−p₀)·n (2)

In some embodiments, to minimize effects of outliers, a criterion may be imposed that the distance must be less than or equal to some threshold dₘₐₓ. That is, although d_{⊥}dₘₐₓ, d_{⊥}=dₘₐₓ may be set instead. It should be understood that the threshold is always set.

It should be understood that because of the use of RANSAC as described herein, a principal component analysis approach is not used. This may be, for example, to avoid any bias that may be induced by a principal component analysis.

The range hypothesis logic 265 generally contains programming instructions for generating a range hypothesis. That is, the programming instructions cause a range to be generated based on one or more points in the point cloud, such as, for example, a plurality of selected points. In some embodiments, the plurality of selected points may be the same points that are selected when running the plane hypothesis logic 264. In other embodiments, at least a portion of the plurality of selected points may be the same points that are selected when running the plane hypothesis logic 264. In yet other embodiments the plurality of selected points may be different points from the points that are selected when running the plane hypothesis logic 264. The range hypothesis logic 265 may further include programming instructions for repeating the generation of a range hypothesis repeatedly for different points, as described in greater detail herein. In some embodiments, the range hypothesis logic 265 may generate a range hypothesis using a random sample consensus (RANSAC) method.

The inlier selection logic 266 generally contains programming instructions for determining and/or selecting one or more inliers from data. For example, one or more inliers may be selected when a range RANSAC method is completed on one or more datasets. In another example, one or more points in a point cloud may be selected as inliers by using the inlier selection logic 266, based on a plane hypothesis. As will be described in greater detail herein, inliers are defined as points that have ranges located within an epsilon tube that results from a RANSAC hypothesis. That is, the inliers represent data that has a distribution that can be explained by a set of model parameters (e.g., can be fit to a line or a particular range).

The outlier selection logic 267 generally contains programming instructions for determining and/or selecting one or more outliers from data. For example, one or more outliers may be selected when a range RANSAC method is completed on one or more datasets. As will be described in greater detail herein, outliers are defined as points that have ranges located outside an epsilon tube that results from a RANSAC hypothesis. An epsilon tube is a margin that is centered on a plane model. A point whose perpendicular distance from the plane is epsilon is inside the epsilon tube. If a point whose perpendicular distance from the plane is outside the epsilon tube, it is considered an outlier. That is, the outliers represent data that has a distribution that does not fit a set of model parameters (e.g., cannot be fit to a line or a particular range (e.g., within the epsilon tube)).

The range calculation logic 268 generally contains programming instructions for completing a range RANSAC method on each of a plurality of datasets (e.g., data obtained from each beam sweep of a LIDAR device). Such a range RANSAC method generally includes measuring range error in the range domain instead of making a plane hypothesis in the x,y,z domain and measuring the z error. Because range observation is a one dimensional signal, the distance can be measured by a simple distance computation. Additional details regarding completion of a range RANSAC method will be described in greater detail herein.

The labeling logic 269 generally contains programming instructions for labeling points in a point cloud as being points associated with the ground or a non-ground object. That is, the labeling logic 269 includes programming instructions for appending point cloud data with additional labeling data, generating XML data corresponding to the point cloud data, generating a lookup file or similar data structure that associates particular points with particular labels, and/or the like.

The component directing logic 270 generally contains programming instructions for communicating with one or more of the components, devices, modules, and/or the like located within the vehicle 100 (FIG. 2A) and/or external to the vehicle 100. For example, the component directing logic 270 may contain communications protocol(s) for establishing a communications connection with a component, device, module, and/or the like such that data and/or signals can be transmitted therebetween. In one specific implementation, the component directing logic 270 may include programming instructions for transmitting a command signal to the one or more vehicle sensor modules 110 (FIG. 2A) and/or a component thereof (e.g., the LIDAR device 204 (FIG. 2A)), the signal directing the one or more vehicle sensor modules 110 and/or a component thereof (e.g., the LIDAR device 204) to sense an environment surrounding a vehicle and generate point cloud data from the sensed environment.

The loss function calculation logic 271 generally contains programming instructions for determining a loss function, which is a function that maps an event or values of one or more variables onto a real number representing a cost associated with the event. In some embodiments, the loss function calculation logic 271 may include programming instructions for computing a loss function from the range hypothesis generated as a result of executing programming instructions contained in the range hypothesis logic 265. Additional details regarding the loss function and how it is computed/calculated will be described in greater detail herein.

The logic modules depicted with respect to FIG. 2B are merely illustrative. As such, it should be understood that additional or fewer logic modules may also be included within the memory 254 without departing from the scope of the present disclosure. In addition, certain logic modules may be combined into a single logic module and/or certain logic modules may be divided into separate logic modules in some embodiments.

Referring now to FIG. 2C, illustrative types of data that may be contained within the storage device 256 are depicted. The types of data may include, but are not limited to, point cloud data 280, sensed data 281, GPS data 282, hypothesis data 283, sorting data 284, loss function data 285, and/or labeling data 286.

Referring to FIGS. 2A and 2C, the point cloud data 280 is generally data pertaining to one or more point clouds. In some embodiments, the point cloud data 280 may particular pertain to one or more point clouds that are generated by the LIDAR device 204 and transmitted by the vehicle sensor module 110 to the labeling system 240.

The sensed data 281 is generally data pertaining to the sensed environment around the vehicle 100. In some embodiments, the sensed data 281 may be any data obtained by the one or more sensing components 214 and transmitted by the vehicle sensor module 110 to the labeling system 240.

The GPS data 282 is generally data pertaining to a location of the vehicle 100. For example, the GPS data 282 may include data that is generated as a result of operation of the GPS receiver 212 and transmitted by the vehicle sensor module 110 to the labeling system 240.

The hypothesis data 283 is generally data pertaining to one or more hypotheses that are generated as a result of execution of the various processes described herein. For example, the hypothesis data 283 may include data pertaining to a plane hypothesis that is generated pertaining to three randomly selected points via a RANSAC method, as described in greater detail herein. In another example, the hypothesis data 283 may include data pertaining to a generated range hypothesis pertaining to a plurality of points according to a RANSAC method, as described in greater detail herein.

The sorting data 284 is generally data pertaining to the classification of data into particular datasets. For example, in some embodiments, the sorting data 284 may include points from point cloud data that has been sorted according to the beam sweep in which the points occur. That is, if a particular point is from a third sweep of a LIDAR beam, the point may be stored in a dataset corresponding to the third sweep of the LIDAR beam. As a result, the various datasets (e.g., sets for each beam sweep of the LIDAR beam) may contain one or more points located therein, which is based upon a sorting process, as described in greater detail herein.

The loss function data 285 is generally the data that is generated as a result of completing a range RANSAC method on each of a plurality of datasets to determine one or more inliers, as described herein. In some embodiments, the loss function data 285 may be stored as a means of determining when the loss function no longer decreases (e.g., by comparing subsequent loss function data entries to determine whether a decrease is observed).

The labeling data 286 may include data pertaining to labels that have been assigned to data, as described herein. In embodiments, the labeling data 286 may be data that is appended to the point cloud data 280 and/or data that is separate from the point cloud data 280 but linked to the point cloud data 280 (e.g., XML data or the like). In some embodiments, the labeling data 286 may indicate whether a particular point in a point cloud pertains to a point on a ground surface or a point on a non-ground object, as discussed in greater detail herein.

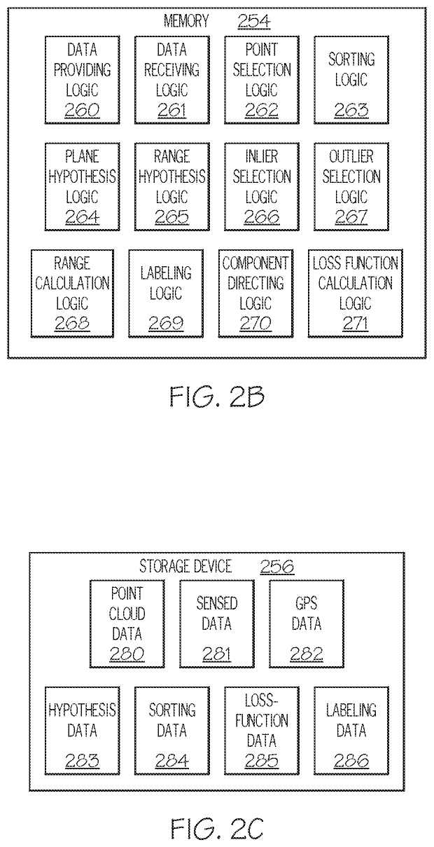

Referring again to FIG. 1, as the one or more vehicle sensor modules 110 on the vehicle 100 sense the environment 120 surrounding the vehicle, the one or more sensors may move in some embodiments. For example, if the one or more vehicle sensor modules 110 contain one or more LIDAR components, particularly scanning LIDAR components, the one or more LIDAR components may sweep (e.g., move in a particular direction) to collect data pertaining to the environment 120. For example, the scanning LIDAR components may rotate clockwise to collect data from areas 360° around the vehicle 100. As such movement and operation of LIDAR components is generally understood, it is not discussed in greater detail herein. As a result of the sweeping movement of the one or more LIDAR components, a plurality of subsequent points are determined along the beam sweep. FIG. 3 schematically depicts a particular arrangement of the plurality of points 302 (e.g., a first point 302a, a second point 302b, a third point 302c, a fourth point 302d, a fifth point 302e, a sixth point 302f, and/or the like) that are observed by the one or more vehicle sensor modules 110 (FIG. 1) located at the vehicle 100.

As is evident from the arrangement of points 302 depicted in FIG. 3, when the LIDAR beam hits the ground surface 130, substantially constant values are returned (e.g., as indicated by the first point 302a, the second point 302b, the third point 302c, the fifth point 302e, and the sixth point 3020. However, when the LIDAR beam hits the non-ground object 140, the range error of that point (e.g., the fourth point 302d) is larger than the error observed from the points located on the ground surface 130 (e.g., the first point 302a, the second point 302b, the third point 302c, the fifth point 302e, and the sixth point 302f). FIG. 3 also depicts epsilon_r (ϵᵣ) and epsilon_z (ϵ_{z}). Epsilon_r represents an amount of error present between where the data indicates the larger error (e.g., where the fourth point 302d is located) versus a hypothetical location of where a substantially constant value would be obtained (e.g., where the fourth point 302d would have occurred if the non-ground object 140 were not present (e.g., if the fourth point 302d had a substantially constant value as the other points (e.g., the first point 302a, the second point 302b, the third point 302c, the fifth point 302e, and the sixth point 302f)). Epsilon_z represents an amount of error present between where the data indicates larger error (e.g., where the fourth point 302d is located) and where an estimated return to a point where a substantially constant value is returned (e.g., a point where the non-ground object 140 contacts the ground surface 130).

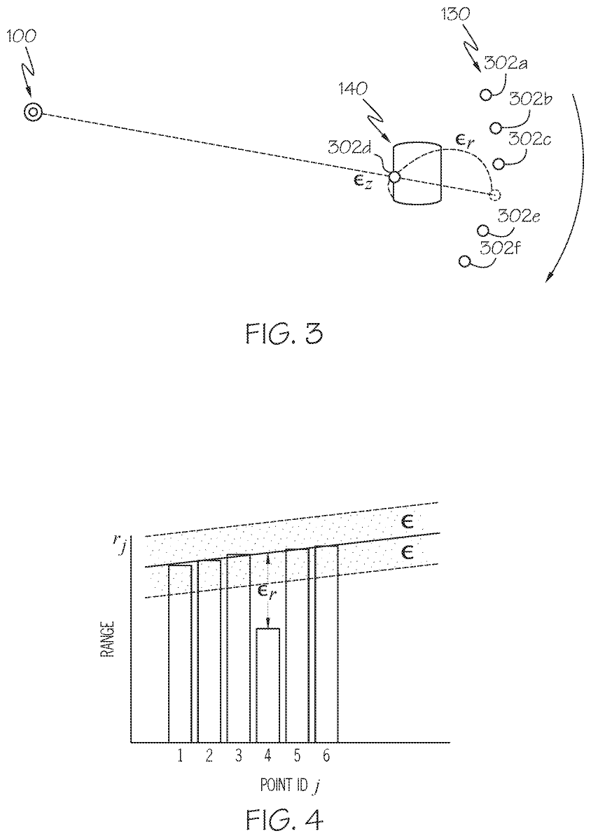

FIG. 4 depicts a plot of the various points 302 (FIG. 3) that is used to determine which of the points contain an error that is not constant, thereby indicating a non-ground object. The points 1-6 that are plotted in FIG. 4 correspond to the points 302a-302f depicted in FIG. 3. Thus, the fourth point 302d, which has been reflected off the non-ground object 140 in FIG. 3 is shown in the plot in FIG. 4 to be not within the expected range of error, as indicated by epsilon_r (ϵᵣ). It should be understood that, of the points depicted in FIGS. 3 and 4, the points containing substantially constant values (e.g., the first point 302a, the second point 302b, the third point 302c, the fifth point 302e, and the sixth point 302f) represent inliers of the data, whereas the points containing a greater amount of range error (e.g., the fourth point 302d) represents outliers of the data.

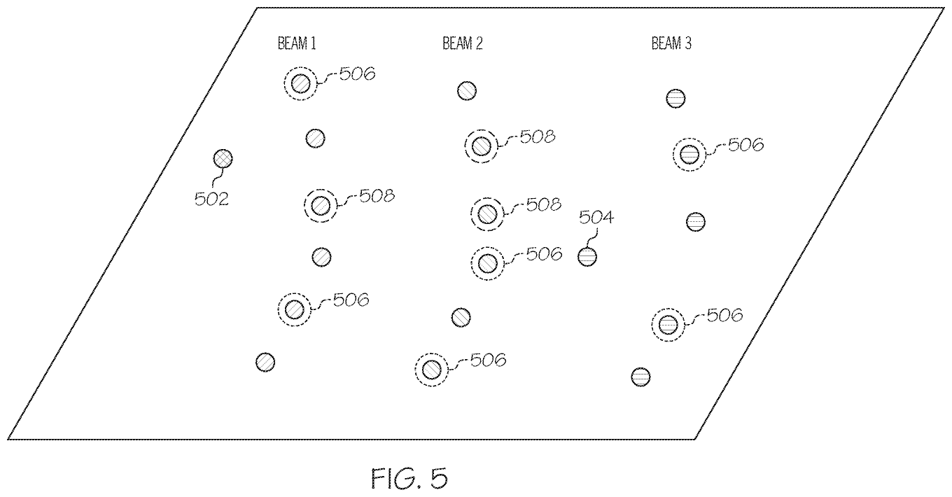

As points are chosen randomly from the point cloud, outliers (e.g., the fourth point 302d) can be rejected based on the plane hypothesis. In addition, from the inliers, multiple line hypotheses can be made for each beam. For example, as depicted in FIG. 5, three beams are depicted (beam 1, beam 2, beam 3). The three beams represent the same general sweep of a LIDAR beam. Point 502 indicates an outlier in the z domain in beam 1 and point 504 indicates an outlier in the range domain in beam 3 (beam 2 does not appear to have any outliers). Various points 508 represent points that were selected for the purposes of making a plane hypothesis, as described herein. In addition, other points 506 represent points that were selected for the purposes of making a line hypothesis in each beam. The inliers in the range domain are defined by criteria indicated by Equation (3) below:

ϵᵣ(i, j)=|r(i, j)−aᵢj−bᵢ|<ϵᵣ (3)

where ϵᵣ(i, j) represents the error in the range coordinate, i,j represent the beam identification (ID) and the point index, r(i, j) represents the range observation of beam ID i of index j (e.g., j-th observation in beam i), aᵢj, bᵢ represent the model parameter of line, each of which belongs to a unique beam.

The inliers in the Euclidean domain are defined by Equation (4) below:

ϵ_{z}(i, j)=|z(i, j)−ax(i, j)−by(i, j)−c|<ϵ_{z} (4)

where ϵ_{z} (i, j) represents error in the z-coordinate, z(i, j) represents a height observation of beam ID i of index j, a, b, and c are plane parameters that are in common among beams, and x(i, j) and y(i, j) represent an observation in x-y coordinate in Euclidean space.

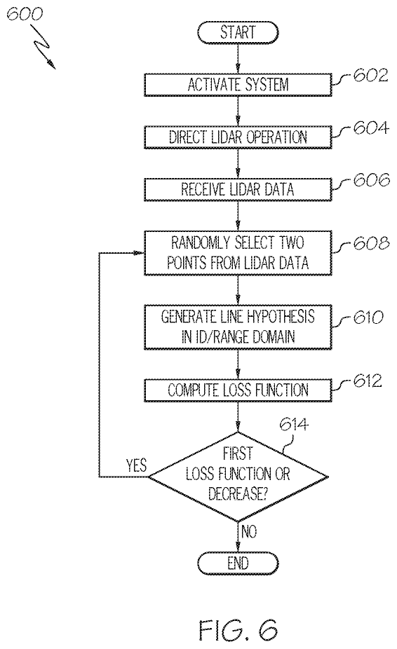

FIG. 6 depicts a flow diagram of an illustrative method 600 of determining a loss function according to one or more embodiments. At block 602, the system may be activated. That is, the various vehicle systems described herein may be powered on or otherwise activated for the purposes of completing the processes described herein. At block 604, operation of the LIDAR device may be directed. That is, one or more signals may be transmitted to the LIDAR device to cause the LIDAR device to sense an environment surrounding the vehicle and generate data (e.g., one or more point clouds) corresponding to the sensed environment.

The LIDAR data is then received at block 606. That is, referring to FIG. 2A, the data generated as a result of operation of the LIDAR device 204 is transmitted via the system interface hardware 210 of the sensor module and the system interface hardware 258 of the labeling system 240 such that the data is received by the labeling system 240. It should be understood that the LIDAR data that is received according to block 606 is point cloud data that includes a plurality of points arranged in three dimensional space. The points may be arranged according to beam (e.g., points from the same beam sweep may be grouped together). Any two of these points (e.g., two points from the same beam sweep) may be selected according to block 608, and a line hypothesis may be generated in the ID/range domain at block 610. The ID is j. That is, multiple observations exist for 0≤j<J in beam i and j represents the index of each point. The hypothesis is randomly selected between two random points following the RANSAC process described above.

At block 612, the loss function is computed from the line hypothesis. The loss function of the line hypothesis represents the negative of the number of the inliers in the range domain. It should be understood that the loss function represents the negative of the number of inliers. Computing the loss function generally includes using Equation (5) below:

aj+b (5)

ϵᵣ(j)=|aj+b+rj|

Equation (5) above represents the distance between the point and the hypothesis. As such, Equation (5) is similar to Equation (3) above, but without the beam id i. Accordingly, a and b are line parameters. The right hand side of Equation (5) is |aj+b+rj|, where rj is the actual range observation and j is the index of that observation. Consider 2D space where the x-axis is the index of the points and the y-axis is the range. As the laser emits light, the points 0, 1, 2, . . . j, . . . , J are obtained in that order.

A decision is made at block 614 as to whether the loss function computed according to block 612 is the first time the loss function has been computed or the loss function is less than a previously computed loss function. If so, the process may repeat at block 608 for two new randomly selected points from the point cloud data. The process according to blocks 608-614 may be repeated as many times as necessary until the computed loss function no longer decreases. At such a time, the process may end.

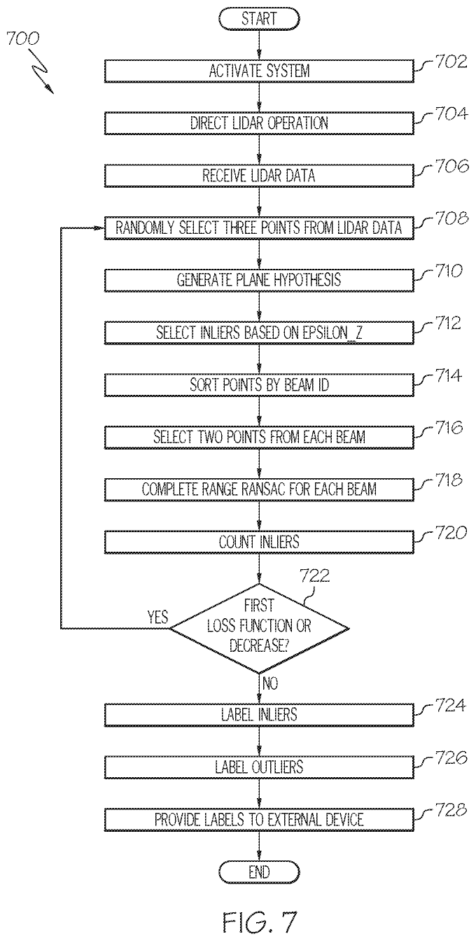

The processes described above with respect to FIG. 6 may be completed for each of the beams independently. Once such a process has been completed, a joint model using range regression and plane regression can be created, as depicted in the flow diagram of FIG. 7. In such a model, a hypothesis of a plane and lines may be made jointly. That is, the method 700 depicted in FIG. 7 includes making a plane hypothesis and a plurality of beam hypotheses. In such a method, randomly chosen points may be selected from a plurality of beams (e.g., the points need not be in the same beam as is the case in FIG. 6 above).

Still referring to FIG. 7, the method 700 includes activating the system at block 702. That is, the various vehicle systems described herein may be powered on or otherwise activated for the purposes of completing the processes described herein. At block 704, operation of the LIDAR device may be directed. That is, one or more signals may be transmitted to the LIDAR device to cause the LIDAR device to sense an environment surrounding the vehicle and generate data (e.g., one or more point clouds) corresponding to the sensed environment.

The LIDAR data is then received at block 706. That is, referring to FIG. 2A, the data generated as a result of operation of the LIDAR device 204 is transmitted via the system interface hardware 210 of the sensor module and the system interface hardware 258 of the labeling system 240 such that the data is received by the labeling system 240. It should be understood that the LIDAR data that is received according to block 706 is point cloud data that includes a plurality of points arranged in three dimensional space. Three points from the point cloud data are randomly selected at block 708.

At block 710, a plane hypothesis is generated from the three randomly selected points. That is, assuming X₁, X₂, and X₃ are the three randomly selected points, an origin p₀ and a normal vector n of the plane hypothesis π including those three points can be generated as follows:

p₀=X₁ n=c₁×c₂ (6)

where c₁=X₂−X₁ c₂=X₃−X₁

At block 712, the inliers based on epsilon_z that are closer to the plane hypothesis are selected. That is, the inliers are selected if they fall within an error range on either side of the plane hypothesis, similar to the line hypothesis depicted in FIG. 4. A point can be rejected first by Euclidean domain and then range domain.

At block 714, all of the selected points are sorted by beam ID. That is, the selected points are grouped together based on the beam in which they were observed. As such, the points are arranged so that all of the selected points in a particular beam sweep are grouped together with each other. For each beam, two points are then selected at block 716. These points can be any of the selected points that were sorted according to block 714. In some embodiments, the points may be identical to the points that were selected for creating the plane hypothesis according to block 708. In some embodiments, the points may be different from the points that were selected for creating the plane hypothesis according to block 708.

At block 718, a range RANSAC method is completed for each beam. That is, the process described hereinabove with respect to FIG. 6 may be completed for each beam. The inliers determined as a result of running the range RANSAC method may be counted at block 720. The inliers may be determined, for example, by using epsilon_r instead of epsilon_z. Thus, the inliers will be similar to the points shown within the shaded area depicted in FIG. 4.

Still referring to FIG. 7, a decision is made at block 722 as to whether the loss function is the first time the loss function has been computed or the loss function is less than a previously computed loss function. If so, the process may repeat at block 708 for three new randomly selected points from the point cloud data. The process according to blocks 708-722 may be repeated as many times as necessary until the computed loss function no longer decreases, thereby ensuring that all of the inliers have been selected. Accordingly, as shown in FIG. 5, the processes described with respect to blocks 708-722 result in a random selection of points from the point cloud and reject the outliers (e.g., point 502) based on a plane hypothesis, as indicated by points 508. From the remaining inliers, a plurality of line hypotheses are made for each beam, and the inliers are rejected, as indicated by points 506. A point can be rejected first by Euclidean domain and then range domain.

At block 724, the inliers are labeled. In some embodiments, the inliers may be labeled as the ground. Labeling the inliers may include, for example, appending one or more data files corresponding to the point cloud data, generating or updating an XML file corresponding to the point cloud data, and/or the like. At block 726, the outliers are labeled. In some embodiments, the outliers may be labeled as a non-ground object. Labeling the outliers may include, for example, appending one or more data files corresponding to the point cloud data, generating or updating an XML file corresponding to the point cloud data, and/or the like.

At block 728, data corresponding to the labels (including data corresponding to the inlier labels and data corresponding to the outlier labels) may be outputted to an external device. That is, referring also to FIG. 2A, the labeling system 240 may transmit, via the system interface hardware 258, data pertaining to the labels (e.g., appended point cloud data, supplemental data, etc.) to an external device. The external device is not limited by this disclosure, and may generally be any device that may use the labeled data. For example, the external device may be a machine learning device that utilizes the data for the purposes of providing one or more autonomous driving decisions and/or one or more semi-autonomous driving decisions. In some embodiments, the external device may be located within the vehicle 100. In other embodiments, the extremal device may be located external to the vehicle 100.

It should now be understood that that the vehicles, systems, and methods described herein provide a particular manner in which point cloud data obtained by a LIDAR device and/or data obtained by other sensors is used to determine whether particular points from the point cloud data correspond to a ground or a non-ground object (e.g., small objects, potholes, and/or the like). The labeling processes described herein increase the speed and accuracy in which a point cloud is automatically labeled before the point cloud is provided to an external device, such as a machine learning computer that executes a machine learning algorithm to further utilize the point cloud data.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of automatically labeling point cloud data, the method comprising:
obtaining, by a processing device, the point cloud data from one or more vehicle sensor modules;
randomly selecting, by the processing device, three points from the point cloud data;
generating, by the processing device, a plane hypothesis pertaining to the three points via a random sample consensus (RANSAC) method;
selecting, by the processing device, one or more points from the point cloud data that are inliers based on the plane hypothesis;
sorting, by the processing device, the selected one or more points based on a corresponding dataset received from the one or more vehicle sensor modules such that each of a plurality of datasets comprises one or more selected points therein;
completing, by the processing device, a range RANSAC method on each of the plurality of datasets to determine one or more inliers of the one or more selected points;
repeating, by the processing device, the randomly selecting, the generating, the selecting, the sorting, and the completing until a loss function of the range RANSAC method does not decrease; and
automatically labeling, by the processing device, the one or more inliers of the one or more selected points in each of the plurality of datasets.

2. The method of claim 1, wherein completing the range RANSAC method comprises:
randomly selecting, by the processing device, two second points from the point cloud data;
generating, by the processing device, a range hypothesis pertaining to the two second points via a RANSAC method;
computing, by the processing device, a second loss function from the range hypothesis; and
repeating, by the processing device, the randomly selecting, the generating, and the computing until the second loss function does not decrease.

3. The method of claim 2, wherein computing the second loss function comprises applying the following equation:
eᵣ(j)=|aj+b−rj|

wherein eᵣ is an outlier point, a and b are outlier points, rj is an actual range observation, and j is an index of the actual range observation.

4. The method of claim 1, further comprising providing, by the processing device, data corresponding to the automatically labeled one or more inliers to an external device.

5. The method of claim 4, wherein the external device is a machine learning device that utilizes the data to make one or more autonomous driving decisions or one or more semi-autonomous driving decisions.

6. The method of claim 1, further comprising automatically labeling, by the processing device, one or more outliers of the one or more selected points in each of the plurality of datasets as a non-ground object.

7. The method of claim 1, wherein automatically labeling the one or more inliers comprises automatically labeling the one or more inliers as a ground surface.

8. The method of claim 1, wherein obtaining the point cloud data comprises obtaining data from one or more vehicle LIDAR devices.

9. The method of claim 1, further comprising directing, by the processing device, the one or more vehicle sensor modules to sense an environment surrounding a vehicle and generate the point cloud data from the sensed environment surrounding the vehicle.

10. A system for automatically labeling point cloud data, the system comprising:
one or more hardware processors; and
a non-transitory, processor-readable storage medium comprising one or more programming instructions thereon that, when executed, cause the one or more hardware processors to:
obtain the point cloud data from one or more vehicle sensor modules,
randomly select three points from the point cloud data,
generate a plane hypothesis pertaining to the three points via a random sample consensus (RANSAC) method,
select one or more points from the point cloud data that are inliers based on the plane hypothesis,
sort the selected one or more points based on a corresponding dataset received from the one or more vehicle sensor modules such that each of a plurality of datasets comprises one or more selected points therein,
complete a range RANSAC method on each of the plurality of datasets to determine one or more inliers of the one or more selected points,
repeat the randomly selecting, the generating, the selecting, the sorting, and the completing until a loss function of the range RANSAC method does not decrease, and
automatically label the one or more inliers of the one or more selected points in each of the plurality of datasets.

11. The system of claim 10, wherein the one or more programming instructions that, when executed, cause the one or more hardware processors to complete the range RANSAC method further cause the one or more hardware processors to:
randomly select two second points from the point cloud data;
generate a range hypothesis pertaining to the two second points via a RANSAC method;
compute a second loss function from the range hypothesis; and
repeat the randomly selecting, the generating, and the computing until the second loss function does not decrease.

12. The system of claim 10, wherein the one or more programming instructions, when executed, further cause the one or more hardware processors to provide data corresponding to the automatically labeled one or more inliers to an external device.

13. The system of claim 10, wherein the one or more programming instructions, when executed, further cause the one or more hardware processors to automatically label one or more outliers of the one or more selected points in each of the plurality of datasets as a non-ground object.

14. The system of claim 10, wherein the one or more programming instructions that, when executed, cause the one or more hardware processors to automatically label the one or more inliers further cause the one or more hardware processors to automatically label the one or more inliers as a ground surface.

15. The system of claim 10, wherein each of the plurality of datasets corresponds to data received from each of a plurality of beam sweeps of a LIDAR device.

16. A vehicle comprising:
one or more vehicle sensor modules arranged to sense an environment surrounding the vehicle; and
a labeling system communicatively coupled to the one or more vehicle sensor modules, the labeling system comprising:
one or more hardware processors; and
a non-transitory, processor-readable storage medium comprising one or more programming instructions thereon that, when executed, cause the one or more hardware processors to:
obtain the point cloud data from the one or more vehicle sensor modules,
randomly select three points from the point cloud data,
generate a plane hypothesis pertaining to the three points via a random sample consensus (RANSAC) method,
select one or more points from the point cloud data that are inliers based on the plane hypothesis,
sort the selected one or more points based on a corresponding dataset received from the one or more vehicle sensor modules such that each of a plurality of datasets comprises one or more selected points therein,
complete a range RANSAC method on each of the plurality of datasets to determine one or more inliers of the one or more selected points,
repeat the randomly selecting, the generating, the selecting, the sorting, and the completing until a loss function of the range RANSAC method does not decrease, and
automatically label the one or more inliers of the one or more selected points in each of the plurality of datasets.

17. The vehicle of claim 16, wherein the vehicle is an autonomous vehicle or a semi-autonomous vehicle.

18. The vehicle of claim 16, wherein the one or more vehicle sensor modules comprises at least one LIDAR device.

19. The vehicle of claim 16, wherein the one or more programming instructions that, when executed, cause the one or more hardware processors to complete the range RANSAC method further cause the one or more hardware processors to:
randomly select two second points from the point cloud data;
generate a range hypothesis pertaining to the two second points via a RANSAC method;
compute a second loss function from the range hypothesis; and
repeat the randomly selecting, the generating, and the computing until the second loss function does not decrease.

20. The vehicle of claim 16, wherein:
the one or more programming instructions, when executed, further cause the one or more hardware processors to automatically label one or more outliers of the one or more selected points in each of the plurality of datasets as a non-ground object; and
the one or more programming instructions that, when executed, cause the one or more hardware processors to automatically label the one or more inliers further cause the one or more hardware processors to automatically label the one or more inliers as a ground surface.
